(19) United States
(12) Patent Application Publication
(10) Pub. No.: US 2019/0128852 A1
(43) Pub. Date: May 2, 2019

(54) PHOTOACOUSTIC APPARATUS

(71) Applicant: CANON KABUSHIKI KAISHA, Tokyo (JP)

(72) Inventor: Yusuke Fukuhara, Tokyo (JP)

(21) Appl. No.: 16/165,977

(22) Filed: Oct. 19, 2018

(30) Foreign Application Priority Data
Oct. 31, 2017 (JP) 2017-210833

(51) Int. Cl. G01N 29/24; H05B 37/02; G01N 29/36

(52) U.S. Cl. CPC G01N 29/2418; G01N 29/36; H05B 37/0209

(57) ABSTRACT

A photoacoustic apparatus includes a light source unit having a plurality of light emitting elements, an acoustic wave detector, and a control unit. The acoustic wave detector converts an acoustic wave generated by irradiating a subject with pulsed light emitted from the light source unit into an electric signal. The control unit controls an amount of a temporal change in a light emission intensity of the light source unit by changing the number of light emitting elements caused to emit the light among the plurality of light emitting elements.

### BACKGROUND OF THE INVENTION

### Field of the Invention

The present disclosure relates to a photoacoustic apparatus.

### Description of the Related Art

In recent years, a research for imaging morphologic information and physiological information, i.e., functional information, in a subject has been in progress in the medical field. In recent years, photoacoustic imaging has been proposed as one of such techniques.

When a living body targeted as the subject is irradiated with light such as pulsed laser light, light of a light emitting diode (LED), and the like, an acoustic wave (typically, an ultrasonic wave) is generated when the light is absorbed by a living tissue in the subject. This phenomenon is called a photoacoustic effect, and the acoustic wave generated due to the photoacoustic effect is called a photoacoustic wave. Tissues constituting the subject absorb optical energy at different rates, and generate photoacoustic waves having different sound pressures. The photoacoustic imaging allows acquisition of characteristic information in the subject such as imaging of a distribution of an optical absorption coefficient by receiving the generated photoacoustic wave by a probe and mathematically analyzing a received signal.

Japanese Patent Application Laid-Open No. 2013-128722 discusses a method for adjusting a pulse width of pulsed light from a light source according to a frequency band of an ultrasonic probe. An image with high image definition can be acquired by setting a narrower pulse width as the frequency band of the ultrasonic probe becomes higher. Further, when the frequency band of the ultrasonic probe is much wider and an image with much higher definition may be acquired, this case necessitates use of a trapezoidal or triangular pulsed wave. In this case, the photoacoustic imaging is largely affected by a rise time and a fall time of the pulsed light, and a ratio of the rise of the pulsed light to the fall thereof have to be controlled according to the frequency band of the acoustic wave receivable by the probe as discussed in Japanese Patent Application Laid-Open No. 2017-46823.

A photoacoustic imaging apparatus discussed in Japanese Patent Application Laid-Open No. 2017-46823, however, changes a speed of a change in a gate voltage of each of field-effect transistors (FETs) connected to light emitting elements to arbitrarily change an amount of a temporal change in the rise and the fall of the pulse. Thus, the change in the voltage needs to be controlled in the order of 100 nanoseconds, so that it is difficult to precisely control the temporal change in the rise and the fall of the pulsed light.

### SUMMARY OF THE INVENTION

The disclosed photoacoustic apparatus can control the amount of the temporal change in the light emission intensity by changing the number of light emitting elements caused to emit the light among the plurality of light emitting elements, thereby allowing precise control of the temporal change in the rise and the fall of the pulsed light.

Further features of the present disclosure will become apparent from the following description of embodiments with reference to the attached drawings.

### BRIEF DESCRIPTION OF THE DRAWINGS

FIG. 1 illustrates an acoustic wave generated from a subject of a photoacoustic apparatus according to each of first and second embodiments of the present invention.

FIG. 2 is a block diagram illustrating an overall configuration of the photoacoustic apparatus according to each of the first and second embodiments of the present invention.

FIG. 3 is a circuit diagram illustrating configurations of switch units and a light source unit in the photoacoustic apparatus according to each of the first and second embodiments of the present invention.

FIG. 4 is a circuit diagram illustrating settings of switches in which two paths in the light source unit are connected in series in the photoacoustic apparatus according to the first embodiment of the present invention.

FIG. 5 is a circuit diagram illustrating settings of switches in which four paths of the light source unit are connected in series in the photoacoustic apparatus according to the first embodiment of the present invention.

FIGS. 6A and 6B illustrate a comparison of a frequency response of the acoustic wave for each number of connected paths in the photoacoustic apparatus according to the first embodiment of the present invention.

FIG. 7 is a circuit diagram illustrating settings of switches in which two paths in the light source unit are connected in parallel in the photoacoustic apparatus according to the second embodiment of the present invention.

FIG. 8 is a circuit diagram illustrating settings of switches in which four paths in the light source unit are connected in parallel in the photoacoustic apparatus according to the second embodiment of the present invention.

FIGS. 9A and 9B illustrate a comparison of a frequency response of the acoustic wave for each number of connected paths in the photoacoustic apparatus according to the second embodiment of the present invention.

### DESCRIPTION OF THE EMBODIMENTS

In the following descriptions, embodiments of the present disclosure will be described with reference to the drawings. However, dimensions, materials, and shapes of components that will be described below, a relative layout among them, and the like may be changed as appropriate according to a configuration of the apparatus to which the present disclosure is applied and various kinds of conditions, and are not intended to limit the scope of the present disclosure to the following descriptions.

A photoacoustic apparatus according to each of the present embodiments is an apparatus that utilizes a photoacoustic effect of receiving an acoustic wave generated inside a subject by irradiating the subject with light (an electromagnetic wave) and acquiring characteristic information inside the subject as image data. The characteristic information acquired at this time indicates distribution of a generation source of the acoustic wave generated by irradiating with the light, distribution of an initial sound pressure inside the subject, or distribution of a density or a coefficient of optical energy absorption that is derived from the distribution of the initial sound pressure, or distribution of a concentration of a substance constituting a tissue. The distribution of the concentration of the substance is, for example, distribution of oxygen saturation or distribution of a concentration of oxygenated hemoglobin or reduced hemoglobin. This characteristic information is also referred to as subject information, and therefore the photoacoustic apparatus according to each of the present embodiments can also be referred to as a subject information acquisition apparatus.

The acoustic wave that will be described in the present embodiments is typically an ultrasonic wave, and includes elastic waves called a sound wave, an ultrasonic wave, and an acoustic wave. The acoustic wave generated due to the photoacoustic effect is called a photoacoustic wave or a photoacoustic-ultrasonic wave. A probe of the subject information acquisition apparatus receives the acoustic wave generated inside the subject.

### <Overall Configuration of Photoacoustic Apparatus>

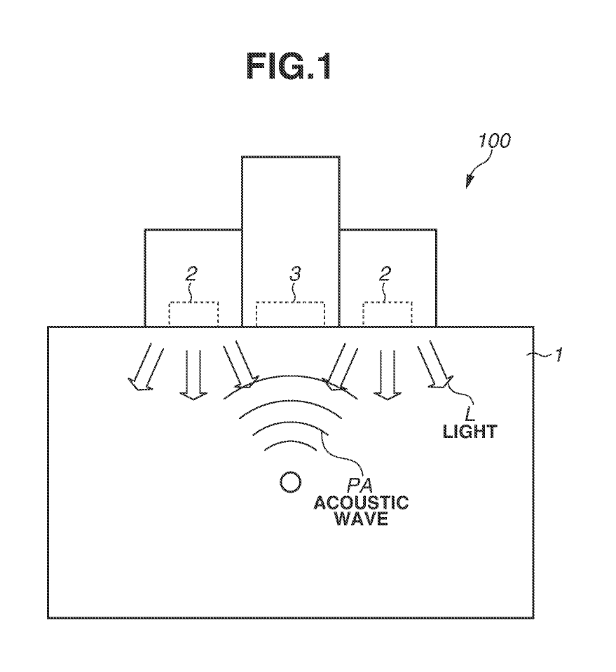

FIG. 1 illustrates an overall configuration of a photoacoustic apparatus 100. The photoacoustic apparatus 100 irradiates a detection target object (a white circle in a subject) in a subject 1 such as a human body with light L from a light source unit 2, and detects an acoustic wave PA generated from the detection target object absorbing the light L with which the detection target object is irradiated by an acoustic wave detector (ultrasonic wave detector) 3.

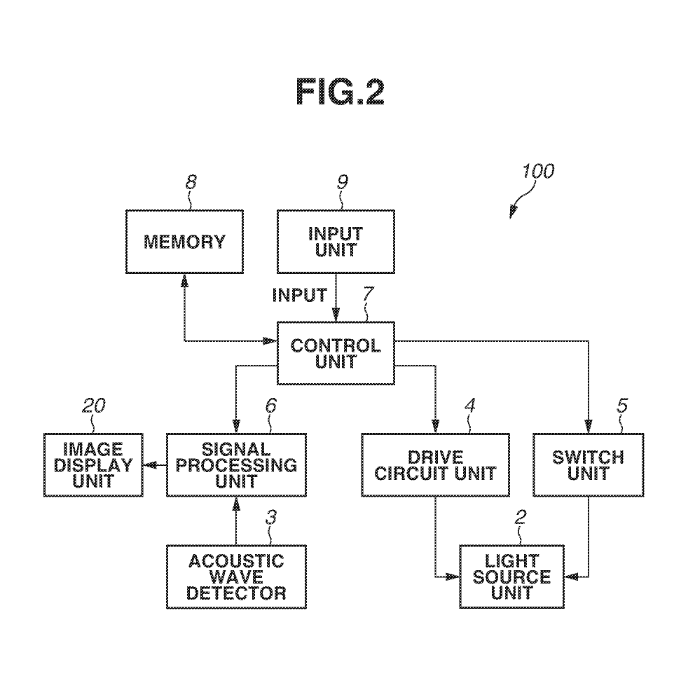

FIG. 2 illustrates control blocks of the photoacoustic apparatus 100. A control unit 7 reads in, from a memory 8, a setting corresponding to a frequency band of the acoustic wave PA that is input from an input unit 9. The control unit 7 switches a switch unit 5 based on the read setting, and instructs a drive circuit unit 4 to start emission of the light L from the light source unit 2 after that. The control unit 7 transmits a signal instructing the drive circuit unit 4 to turn off the light L of the light source unit 2 after causing the light source unit 2 to emit the light L during a set time period.

The control unit 7 transmits a signal instructing a signal processing unit 6 to sample acoustic wave data detected by the acoustic wave detector 3 at a predetermined timing. The signal processing unit 6 forms an image of the detection target object based on the acquired acoustic wave data, and transmits the image to an image display unit 20. The image display unit 20 displays the received image.

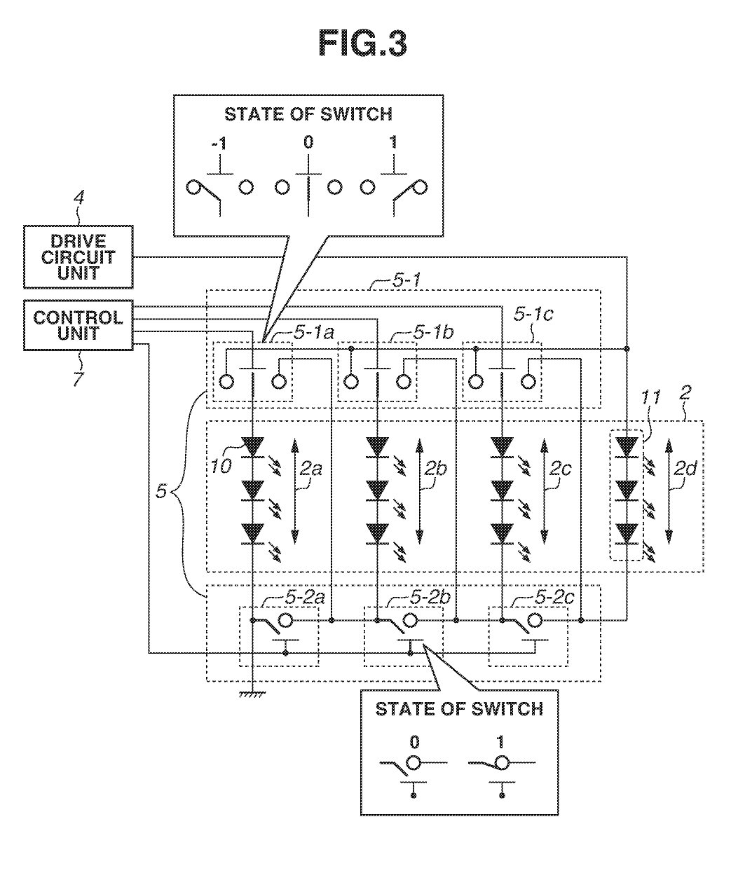

FIG. 3 is a circuit diagram illustrating details of the switch units 5 and the light source unit 2 illustrated in FIG. 1. Switch units 5-1 (5-1a, 5-1b, and 5-1c) each have any of states −1, 0, and 1. Switch units 5-2 (5-2a, 5-2b, and 5-2c) each have any of states 0 and 1. The control unit 7 sets each of the states of the switch units 5 (5-1 and 5-2) and the drive circuit unit 4 to determine a voltage or a current to he applied to paths 2 (2a, 2b, 2c, and 2d), thereby determining a total light amount to be emitted from light emitting elements. In the example illustrated in FIG. 3, three light emitting diodes (LEDs) are arranged per path 2, and four paths 2 are arranged; however, an element other than the LED may be used as the light emitting element, and the number of light emitting elements per path and the number of paths may be set to any values. In an example, the paths 2 are arranged so as to be located horizontally symmetrically on a light emission surface from a viewpoint of evenness of light distribution. Accordingly, the number of paths is set to a multiple of 2.

Details of the overall configuration of the photoacoustic apparatus 100 according to the present embodiments will be described with reference to FIGS. 1 to 3. The photoacoustic apparatus 100 according to the present embodiments includes the light source unit 2 including a plurality of light emitting elements 10, and the acoustic wave detector 3 that converts the acoustic wave PA generated by irradiating the subject 1 with pulsed light emitted from the light source unit 2 into an electric signal. Then, the photoacoustic apparatus 100 includes the control unit 7 that controls an amount of a temporal change in a light emission intensity of the light source unit 2 by changing the number of light emitting elements 10 caused to emit the light L among the plurality of light emitting elements 10.

The photoacoustic apparatus 100 will be described, for example, assuming that the light source unit 2 includes a plurality of light emitting element arrays 11 each including the plurality of light emitting elements 10 connected in series as illustrated in FIG. 3. In such a configuration, the control unit 7 can control the amount of the temporal change in the light emission intensity of the light source unit 2 by switching between a state in which the plurality of light emitting element arrays 11 is not electrically connected to one another and a state in which the plurality of light emitting element arrays 11 is connected to one another in series. For example, when the states of the switches (5-1a, 5-1b, and 5-1c) are (0, 0, and 0) and the states of the switches (5-2a, 5-2b, and 5-2c) are (0, 0, and 0), this is a state in which the plurality of light emitting element arrays 11 is not electrically connected (state 1). Next, when the states of the switches (5-1a, 5-1b, and 5-1c) are (1, 0, and 0) and the states of the switches (5-2a, 5-2b, and 5-2c) are (0, 0, and 0), a light intensity P1 is output from the light source unit 2 during a time period t1 (state 2). Further, when the states of the switches (5-1a, 5-1b, and 5-1c) are (1, 1, and 1) and the states of the switches (5-2a, 5-2b, and 5-2c) are (0, 0, and 0), light that is four times as intense as the light intensity P1 is output from the light source unit 2 during the time period t1 (state 3). In this manner, the control unit 7 can control the amount of the temporal change in the light emission intensity of the light source unit 2 by switching between the state in which the plurality of light emitting element arrays 11 is not electrically connected to one another and the state in which the plurality of light emitting element arrays 11 is connected to one another in series.

When the states of the switches (5-1a, 5-1b, and 5-1c) are (−1, 0, and 0) and the states of the switches (5-2a, 5-2b, and 5-2c) are (1, 0, and 0), a light intensity P2 is output from the light source unit 2 during a time period t2 (state 4). Then, when the states of the switches (5-1a, 5-1b, and 5-1c) are (−1, −1, and −1) and the states of the switches (5-2a, 5-2b, and 5-2c) are (1, 1, and 1), light that is twice as intense as the light intensity P2 is output from the light source unit 2 during the time period t2 (a state 5). In this manner, the control unit 7 can control the amount of the temporal change in the light emission intensity of the light source unit 2 by switching between the state in which the plurality of light emitting element arrays 11 is not electrically connected to one another and a state in which the plurality of light emitting element arrays 11 is connected to one another in parallel.

In this manner, the photoacoustic apparatus 100 can control the amount of the temporal change in the light emission intensity of the light source unit 2 by limiting control to changing the state of the connection of the plurality of light emitting element arrays 11 to one another, and does not have to change an amount of a temporal change in the voltage in a short time period, thereby allowing precise control of a temporal change in a rise and a fall of the pulsed light compared to that in the conventional technique.

The photoacoustic apparatus 100 can switch between the state in which the plurality of light emitting element arrays 11 is connected to one another in series and the state in which the plurality of light emitting element arrays 11 is connected to one another in parallel by the switch units 5 as described above.

A constant voltage is applied to the plurality of light emitting element arrays 11 connected in parallel as in the above-described states 4 and 5 by the drive circuit unit 4. The light source unit 2 is configured in such a manner that a constant current flows in the plurality of light emitting element arrays 11 connected in series as in the above-described states 2 and 3 by the drive circuit unit 4.

The number of light emitting element arrays 11 of the light source unit 2 may be a multiple of 2.

The type of the light emitting element 10 is not specifically limited, and a light emitting diode or a laser diode can be used as the light emitting element 10.

The acoustic wave detector 3 may include a piezoelectric transducer or a capacitive transducer.

The photoacoustic apparatus 100 may be a hand-held type probe. The photoacoustic apparatus 100 may further include an information acquisition unit that acquires information about the subject 1 based on at least the electric signal output from the acoustic wave detector 3.

### <Control of Amount of Temporal Change in Light Emission Intensity>

The light emitting element(s) 10 caused to emit the light L among the plurality of light emitting elements 10 may be determined in advance in correspondence with the amount of the temporal change in the light emission intensity.

The amount of the temporal change in the light emission intensity of the light source unit 2 may be controlled by changing the number of light emitting element arrays 11 caused to emit the light L and the number of light emitting element arrays 11 not caused to emit the light L among the plurality of light emitting element arrays 11.

The plurality of light emitting element arrays 11 may be arrayed in a specific direction with respect to one another and may be arranged in such a manner that the light emitting element arrays 11 not caused to emit the light L are not located adjacent to each other. For example, the light emitting element arrays 11 caused to emit the light L can be arranged with two or more light emitting element arrays 11 not caused to emit the light L provided therebetween. Alternatively, the light emitting element arrays 11 caused to emit the light L may be arranged so as not to be located adjacent to each other. For example, one light emitting element array 11 not caused to emit the light L can be provided between the light emitting element arrays 11 caused to emit the light L. Any of the configurations can suppress deviation of light emission positions.

The plurality of light emitting elements 10 may be arranged in a two-dimensional matrix form. In this case, the control unit 7 can control the amount of the temporal change in the light emission intensity of the light source unit 2 by changing the number of light emitting elements 10 caused to emit the light L and the number of light emitting elements 10 not caused to emit the light L among the plurality of light emitting elements 10. The above-described light emitting elements 10 not caused to emit the light L can be arranged so as not to be located adjacent to each other. The light emitting elements 10 caused to emit the light L can be arranged so as not to be located adjacent to each other. Any of the configurations can suppress deviation of the light emission positions.

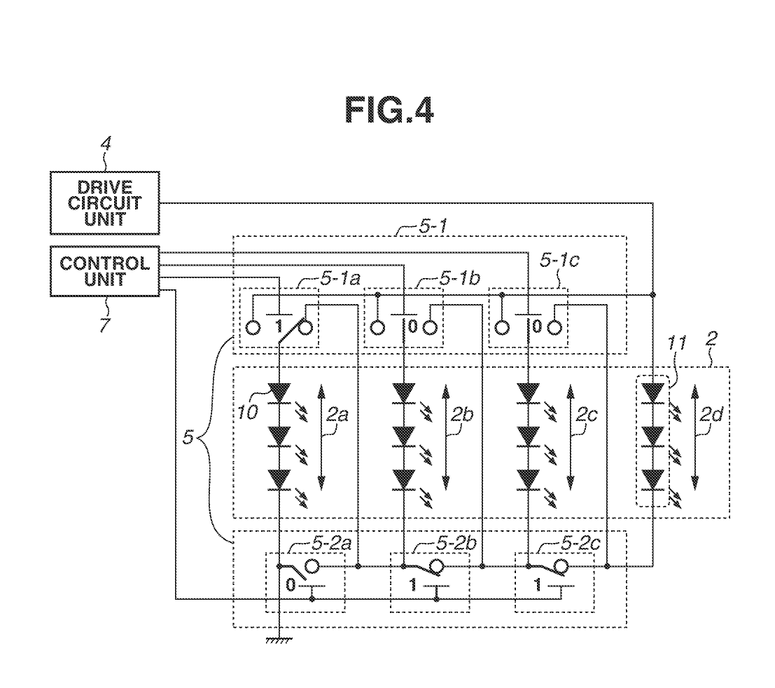

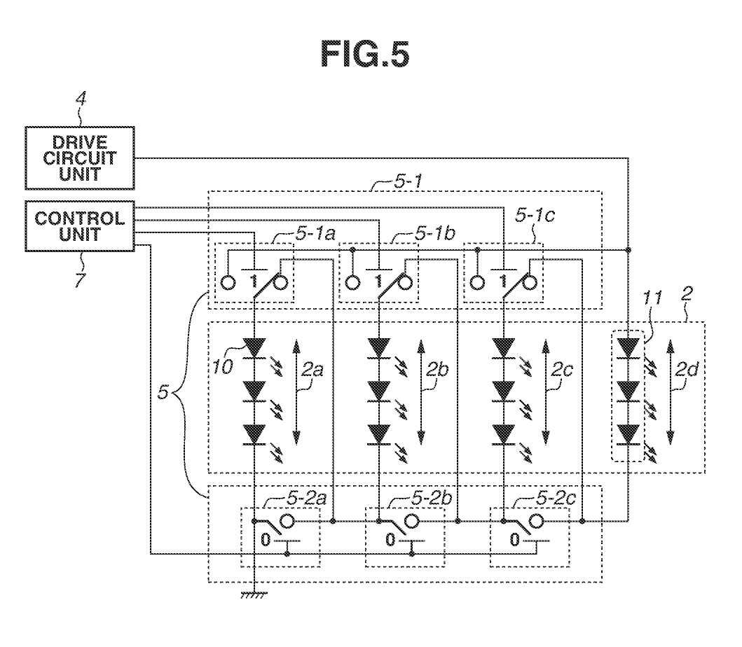

FIGS. 4, 5, 6A, and 6B illustrate the first embodiment. In the first embodiment, a method for driving the light emitting elements 10 is a constant current method. The control unit 7 sets each of the switch units 5 in such a manner that a setting 1B illustrated in FIG. 5 outputs a pulsed wave having a light amount that is twice as large as a setting 1A illustrated in FIG. 4.

FIG. 4 is a circuit diagram illustrating details of the switch units 5 and the light source unit 2 in the setting 1A. In the setting 1A, the switch 5-1a, the switch 5-1b, the switch 5-1c, the switch 5-2a, the switch 5-2b, and the switch 5-2c are set to 1, 0, 0, 0, 1, and 1, respectively, and therefore the paths 2a and 2d are connected in series. The constant current is applied to the light source unit 2 for 90 ns under a condition of the setting 1A, and the application thereof is stopped after that. At this time, the application time period of 90 ns is shorter than a time period required for a light amount of the LED to be saturated.

FIG. 5 is a circuit diagram illustrating details of the switch units 5 and the light source unit 2 in the setting 1B. In the setting 1B, the switch 5-1a, the switch 5-1b, the switch 5-1c, the switch 5-2a, the switch 5-2b, and the switch 5-2c are set to 1, 1, 1, 0, 0, and 0, respectively, and therefore the paths 2a, 2b, 2c, and 2d are connected in series. The constant current is applied to the light source unit 2 for 90 ns under a condition of the setting 1B, and the application thereof is stopped after that. At this time, the application time period of 90 ns is shorter than the time period required for the light amount of the LED to be saturated.

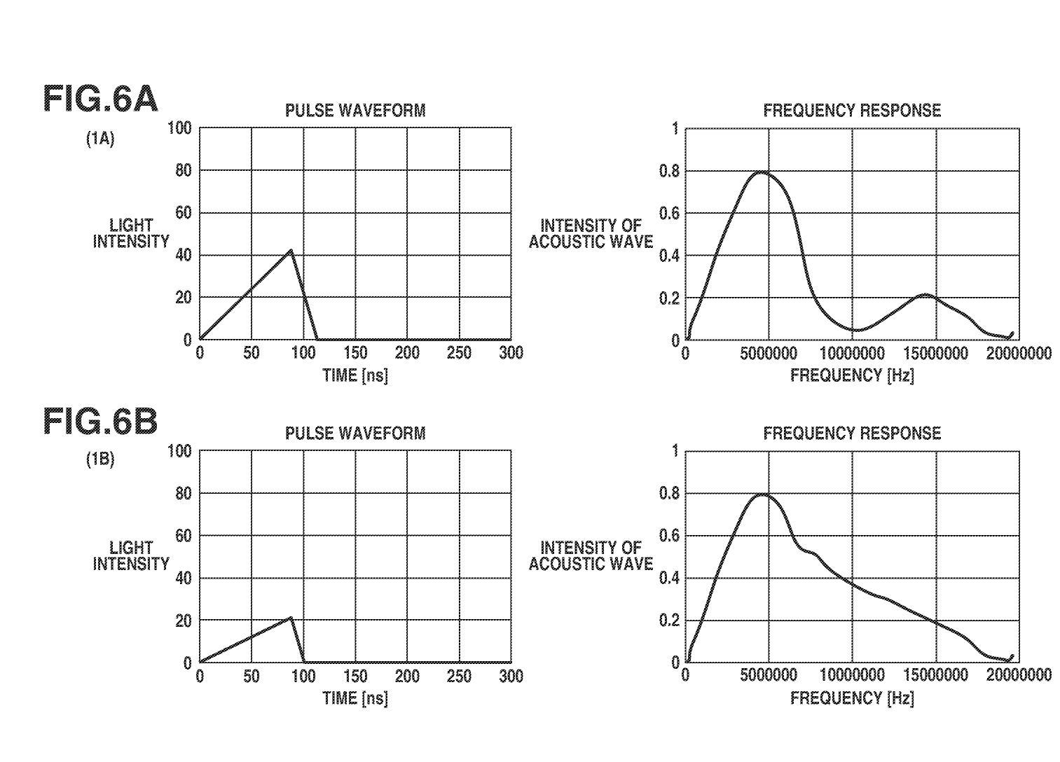

FIGS. 6A and 6B illustrate a comparison between frequency responses of the acoustic wave PA in the settings 1A and 1B. FIGS. 6A and 6B illustrate results of the settings 1A and 1B, respectively. According to FIG. 6A, the pulsed wave exhibits slopes at a ratio (the rise/the fall) of 1/4. According to FIG. 6B, the pulsed wave exhibits slopes at a ratio of 1/2. The ratio of the slopes in the setting 1B is twice as high as the ratio of the slopes in the setting 1A because the setting 1B uses the four paths (2a, 2b, 2c, and 2d) while the setting 1A uses the two paths (2a and 2d). As a result, the setting 1B generates a total light amount that is twice as large as that of the setting 1A, and allows a higher-frequency component to be extracted in the frequency response of the acoustic wave PA.

According to the first embodiment, in a case where the photoacoustic apparatus 100 uses an ultrasonic probe having a wide frequency band, this configuration can be dealt with by switching the settings of the switch units 5 to increase the number of light emitting element arrays 11 connected in series, thereby increasing the ratio of the slopes of the pulse. Meanwhile, in a case where the photoacoustic apparatus 100 uses an ultrasonic probe having only a low-frequency band, this configuration can be dealt with by switching the settings of the switch units 5 to reduce the number of light emitting element arrays 11 connected in series, thereby reducing the ratio of the slopes of the pulse. The above-described photoacoustic apparatus 100 can easily switch the settings according to the frequency band of the ultrasonic probe without changing the applied current. Accordingly, the photoacoustic apparatus 100 can reduce or eliminate necessity of a current detector, a control circuit, and the like, thereby achieving a cost reduction.

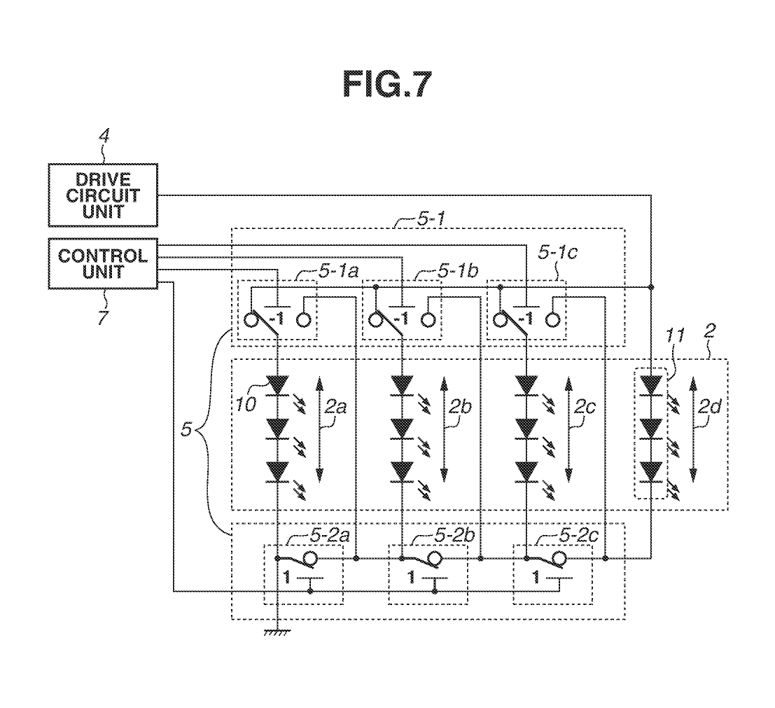

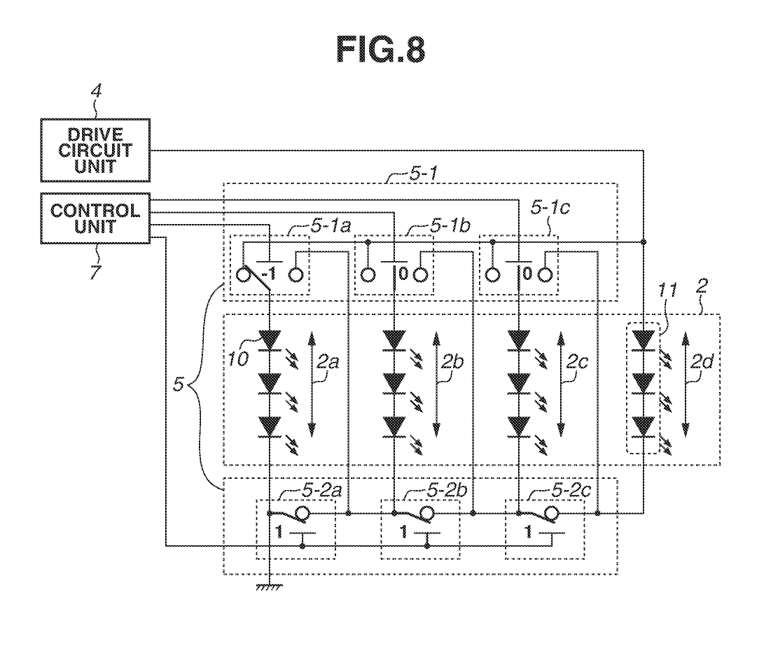

FIGS. 7, 8, and 9A and 9B illustrate the second embodiment. A difference from the first embodiment is that a constant voltage method is employed as the method for driving the light emitting elements 10 in the second embodiment while the constant current method is employed as the method therefor in the first embodiment. Components similar to the components in the above-described first embodiment will be denoted by the same reference numerals, and descriptions thereof will be omitted. The control unit 7 sets each of the switch units 5 in such a manner that a setting 2B illustrated in FIG. 7 outputs a pulsed wave having a light amount that is twice as large as that of a setting 2A illustrated in FIG. 8.

FIG. 8 is a circuit diagram illustrating details of the switch units 5 and the light source unit 2 in the setting 2A. In the setting 2A, the switch 5-1a, the switch 5-1b, the switch 5-1c, the switch 5-2a, the switch 5-2b, and the switch 5-2c are set to −1, 0, 0, 1, 1, and 1, respectively, and therefore the paths 2a and 2d are connected in parallel. The constant voltage is applied to the light source unit 2 for 90 ns under a condition of the setting 2A, and the application thereof is stopped after that. At this time, the application time period of 90 ns is shorter than the time period required for the light amount of the LED to be saturated.

FIG. 7 is a circuit diagram illustrating details of the switch units 5 and the light source unit 2 in the setting 2B. In the setting 2B, the switch 5-1a, the switch 5-1b, the switch 5-1c, the switch 5-2a, the switch 5-2b, and the switch 5-2c are set to −1, −1, −1, 1, 1, and 1, respectively, and therefore the paths 2a, 2b, 2c, and 2d are connected in parallel. The constant voltage is applied to the light source unit 2 for 90 ns under a condition of the setting 2B, and the application thereof is stopped after that. At this time, the application time period 90 ns is shorter than the time period required for the light amount of the LED to be saturated.

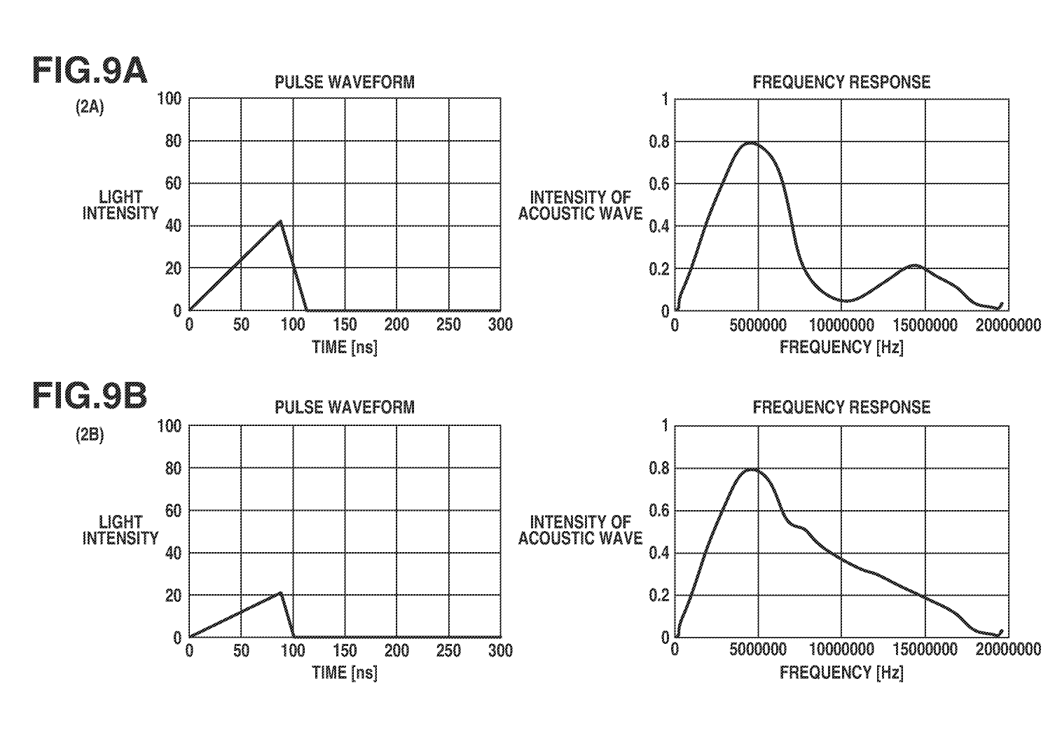

FIGS. 9A and 9B illustrate a comparison between frequency responses of the acoustic wave PA in the settings 2A and 2B. FIGS. 9A and 9B illustrate results of the settings 2A and 2B, respectively. According to FIG. 9A, the pulsed wave exhibits slopes at a ratio (the rise/the fall) of 1/4. According to FIG. 9B, the pulsed wave exhibits slopes at a ratio of 1/2. The ratio of the slopes in the setting 2B is twice as high as the ratio of the slopes in the setting 2A because the setting 2B uses the four paths (2a, 2b, 2c, and 2d) while the setting 2A uses the two paths (2a and 2d). As a result, the setting 2B generates a total light amount that is twice as large as the setting 2A, and allows a higher-frequency component to be extracted in the frequency response of the acoustic wave PA.

According to the second embodiment, in a case where the photoacoustic apparatus 100 uses an ultrasonic probe having a wide frequency band, this configuration can be dealt with by switching the setting of the switch units 5 to increase the number of LED arrays connected in parallel, thereby increasing the ratio of the slopes of the pulse. Meanwhile, in a case where the photoacoustic apparatus 100 uses an ultrasonic probe having only a low-frequency band, this configuration can be dealt with by switching the settings of the switch units 5 to reduce the number of LED arrays connected in parallel, thereby reducing the ratio of the slopes of the pulse. The above-described photoacoustic apparatus 100 can easily switch the settings according to the frequency band of the ultrasonic probe without changing the applied voltage. Accordingly, the photoacoustic apparatus 100 can reduce or eliminate necessity of a voltage detector, a control circuit, and the like, thereby achieving a cost reduction.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2017-210833, filed Oct. 31, 2017, which is hereby incorporated by reference herein in its entirety.

What is claimed is:

1. A photoacoustic apparatus comprising:
a light source unit including a plurality of light emitting elements;
an acoustic wave detector configured to convert an acoustic wave generated by irradiating a subject with pulsed light emitted from the light source unit into an electric signal; and
a control unit configured to control an amount of a temporal change in a light emission intensity of the light source unit by changing the number of light emitting elements caused to emit the light among the plurality of light emitting elements.

2. The photoacoustic apparatus according to claim 1, wherein the light source unit includes a plurality of light emitting element arrays including plural light emitting elements connected in series.

3. The photoacoustic apparatus according to claim 2, wherein the control unit controls the amount of the temporal change in the light emission intensity of the light source unit by switching between a state in which the plurality of light emitting element arrays is not electrically connected to one another and a state in which the plurality of light emitting element arrays is connected to one another in series.

4. The photoacoustic apparatus according to claim 3, further comprising a drive circuit unit configured to supply a constant current to the plurality of light emitting element arrays connected in series.

5. The photoacoustic apparatus according to claim 2, wherein the control unit controls the amount of the temporal change in the light emission intensity of the light source unit by switching between a state in which the plurality of light emitting element arrays is not electrically connected to one another and a state in which the plurality of light emitting element arrays is connected to one another in parallel.

6. The photoacoustic apparatus according to claim 5, further comprising a drive circuit unit configured to apply a constant voltage to the plurality of light emitting element arrays connected in parallel.

7. The photoacoustic apparatus according to claim 2, further comprising a switch unit figured to switch between a state in which the plurality of light emitting element arrays is connected to one another in series and a state in which the plurality of light emitting element arrays is connected to one another in parallel.

8. The photoacoustic apparatus according to claim 2, wherein the number of light emitting element arrays in the light source unit is a multiple of 2.

9. The photoacoustic apparatus according to claim 2, wherein the control unit controls the amount of the temporal change in the light emission intensity of the light source unit by changing the number of light emitting element arrays caused to emit the light and the number of light emitting element arrays not caused to emit the light among the plurality of light emitting element arrays.

10. The photoacoustic apparatus according to claim 9,
wherein the plurality of light emitting element arrays is arrayed in a specific direction with respect to one another, and
wherein the light emitting element arrays not caused to emit the light are not located adjacent to each other.

11. The photoacoustic apparatus according to claim 9,
wherein the plurality of light emitting element arrays is arrayed in a specific direction with respect to one another, and
wherein the light emitting element arrays caused to emit the light are not located adjacent to each other.

12. The photoacoustic apparatus according to claim 1,
wherein the plurality of light emitting elements is arranged in a two-dimensional matrix form, and
wherein the control unit controls the amount of the temporal change in the light emission intensity of the light source unit by changing the number of light emitting elements caused to emit the light and the number of light emitting elements not caused to emit the light among the plurality of light emitting elements.

13. The photoacoustic apparatus according to claim 12, wherein the light emitting elements not caused to emit the light are not located adjacent to each other.

14. The photoacoustic apparatus according to claim 12, wherein the light emitting elements caused to emit the light are not located adjacent to each other.

15. The photoacoustic apparatus according to claim 1, wherein the light emitting element caused to emit the light among the plurality of light emitting elements is determined in advance in correspondence with the amount of the temporal change in the light emission intensity.

16. The photoacoustic apparatus according to claim 1, wherein each of the light emitting elements is a light emitting diode or a laser diode.

17. The photoacoustic apparatus according to claim 1, wherein the acoustic wave detector includes a piezoelectric transducer.

18. The photoacoustic apparatus according to claim 1, wherein the acoustic wave detector includes a capacitive transducer.

19. The photoacoustic apparatus according to claim 1, wherein the photoacoustic apparatus is a hand-held type probe.

20. The photoacoustic apparatus according to claim 1, further comprising an information acquisition unit configured to acquire information about the subject based on at least the electric signal.

21. A method for a photoacoustic apparatus having a light source unit including a plurality of light emitting elements, the method comprising:
converting an acoustic wave generated by irradiating a subject with pulsed light emitted from the light source unit into an electric signal; and
controlling an amount of a temporal change in a light emission intensity of the light source unit by changing the number of light emitting elements caused to emit the light among the plurality of light emitting elements.
